(19) United States
(12) Patent Application Publication
(10) Pub. No.: US 2007/0100751 A1
(43) Pub. Date: May 3, 2007

(54) Method and system for processing and preventing credit card fraud in simultaneous remote wholesale exchange and local fullfillment of retail transactions by third party retailers

(76) Inventor: Lorenzo Carver, Boulder, CA (US)

Correspondence Address: Wilson Daniel Swayze, Jr, 3804 Clearwater Ct, Plano, TX, 75025, US

(21) Appl. No.: 11/264,523

(22) Filed: Nov. 1, 2005

(51) Int. Cl. G06Q 40/00

(52) U.S. Cl. 705/44; 705/39

(57) ABSTRACT

A method for completing a card transaction for a consumer includes the steps of presenting card information relating to the card transaction to a first merchant online in order to pay for the merchandise to be delivered to the consumer, submitting the card information through a gateway of the first merchant to obtain payment approval, selecting a second merchant to supply the merchandise to the consumer, initiating a verification process by the second merchant by using a gateway of the second merchant to only verify that the card was used to purchase the merchandise, and settling the purchase for the first and second merchants with the card information in accordance with the payment approval.

### FIELD OF THE INVENTION

The present invention relates to technology for processing and preventing fraud in online credit card transactions where the merchandise is sold to the consumer online by one merchant and picked up at a physical store belonging to another merchant.

### BACKGROUND OF THE INVENTION

Large national and regional retail chains have been providing local pickup options for customers that order online for several years now. These large organizations typically invest tens of millions of dollars in operational infrastructure, and millions more in web based systems that link their supply chains, inventory and pricing information to allow a convenient experience for consumers. The value of a customer that can come to a physical location to pickup a product ordered online is greater than the value of a customer that simply orders a product online and has the product delivered by a common carrier or other delivery service. This additional value is composed, in part, by the reduced cost of getting that customer into a physical environment where they are likely to make an impulse purchase or become aware of future purchases they may not have considered while searching for a specific item online

Small and medium sized retailers that operate within a limited geographic area, for instance a State or City, rarely have the volume of business that can justify spending tens of millions of dollars for an operational infrastructure, and certainly can't justify spending millions more to purchase and integrate such a system with web based systems that link their supply chains, inventory and pricing information.

Credit card verification and processing is a critical component of facilitating transactions where the consumer orders an item online and picks the item up at a local retail store. In the case of a small, independent retailer, the physical retail outlets that are available for consumers to pick up merchandise ordered in an online transaction are very limited, both by the number of outlets and the constraints of prior art credit card processing and fraud prevention systems.

Large retailers, under common control of a single entity, benefit from lower credit card processing costs, as a function of their size and resulting bargaining power with processing companies. Small retailers, especially small retailers that attempt to expand their businesses by selling on the Internet, are routinely subjected to processing rates twice as high as those experienced by large retailers. This, of course, puts these retailers at a substantial cost disadvantage competitively. Many processors cite the increased risk of fraud on the Internet, where credit cards are entered, as opposed to in store transactions where a physical credit card is presented as the reason.

FIG. 3 is a flow chart of the prior art method and apparatus for processing a physical (swiped) credit card transaction for a single retailer. The prior art method 300, typically involves a consumer 310 presenting their card to the retailer who swipes or enters 311 the card number. The retailer either indicates or the system otherwise determines 312 that the swipe is for a sale transaction 313. The credit card terminal transmits the card and transaction data to the processor 314, such processor who will automatically determine the type of credit card association 315 and transmit the authorization request to the proper card issuer. The card issuer will receive the authorization request from the processor 316 and either approve or deny 317 the request for authorization. If the request is not approved, the retailer will advise the customer of the denial 318. If the request is approved, the retailer will typically have the customer sign a sales draft 319 and then tender the goods purchased to the consumer 320. Following approval, the retailer will use any one of a number of well known routines within the art to capture the transaction and request settlement. The issuing bank will transmit funds to the acquiring bank 321 and the acquiring bank (sometimes through another processor) will transmit funds to the retailer's bank account.322. As illustrated, the prior art method contemplates swiping cards for transactions (sales, or returns) that originated at the selling merchant's physical store only. This prior art method does not allow for the merchant to verify a transaction by swiping a credit card and or delivering product for another third party merchant (the Selling Retailer) that has made an online sale to a consumer that is not within the practical geographic trade area of the Selling Retailer's physical store. Similarly, such prior art system does not contemplate that the Selling Retailer would have simultaneously purchased, borrowed or otherwise provisioned the item(s) sold to the consumer from Wholesale Delivery Member store where the credit card is being swiped on a terminal, POS or other computing device.

FIG. 6 is a flow chart of a process flow of the prior art method and apparatus for processing an online credit card transaction for a single retailer, with the item shipped to the customer. The prior art method 600, typically begins after a consumer has selected goods from a retailer's web site and has clicked on to a checkout page 610. The consumer enters their payment (credit or debit card) information in a secure environment web page 611 (for instance, a Secure Socket Layer or SSL page). After the consumer instructs the secure page to do so, typically by clicking a submit button or series of buttons, the merchant web page connects to the Internet Payment Gateway (or “Gateway”) and sends encrypted information regarding the transaction and payment card to the Gateway 613. The Gateway decrypts this transaction and payment information and automatically routs the information to the retailer's credit card processor 614. The credit card processor's system automatically detects the type of credit card association related and transmits a request for authorization to the association 615. The card issuer receives the authorization request 616 and transmits an approval or denial of the request for authorization 617 to the processor. The processor then transmits this approval or denial to the Gateway 618, which will send an encrypted approval or denial to the secure retailer web page being viewed by the consumer 619. If the request is not approved, the retailer web page will advise the consumer of the denial 621. If the request is approved, the retailer will typically display an approval code and message and then ship the goods to the consumer 622. The retailer will typically then transmit a request for settlement, through their online gateway or offline, and their processor will have finds transmitted from the issuing bank to the acquiring bank 623 and from the acquiring bank to the retailer's bank account 624. As illustrated, the prior art method contemplates processing, online electronically through a gateway, sales that originated at the selling merchant's online store only. This prior art method does not allow for the merchant have the transaction approved on their web site and later have the credit or debit card presented to a third-party retailer (the Wholesale Delivery Member) that is within the practical geographic trade area of the Selling Retailer's customer, enabling the Wholesale Delivery member to verify a transaction by swiping a credit card and or delivering product for the Selling Retailer that had the online order approved for a consumer that is not within the practical geographic trade area of the Selling Retailer's physical store.

### BRIEF SUMMARY OF THE INVENTION

Given a method and apparatus that enables independent retail entities, which share a common product focus, to exchange the provisioning of a physical presence for nationwide prospects, the ability of one distinct remote merchant that sells an online product to allow another distinct member merchant that become aware and interested in their offerings via the web, while simultaneously enabling those retailers to exchange and or lend products between one another electronically, allowing the remote Selling Retailer's obligation to a remote online customer to be physically fulfilled by a local retailer (Wholesale Delivery Member) whose transaction is exclusively with the Selling Retailer, on a wholesale basis, a need arises for a method of processing and clearing each of the transactions that result.

Given another embodiment of the aforementioned invention, such embodiment that would allow retailers that did not physically have the product in inventory to offer the product for sale at their unique pricing (presumably lower than other member retailers), in remote trade areas, and satisfy their obligations to physically deliver the purchased item through to the remote retailer in cash instead of physically replacing the item they borrowed or purchased from the remote retailer, a need arises for a method of processing and clearing each of the transactions that result.

A system and apparatus connects all parties to a central, shared processor, allowing member independent retailers to reduce risks to the processor, physically verify and or swipe the consumers credit card on behalf of a third party retailer that has sold product to the consumer on the Internet, and clear wholesale transactions between retailers in real time.

Under the preferred embodiment, the delivering wholesaling retailer would swipe the consumer's card through the delivering retailers existing card reader on behalf of the selling retailer.

Under another embodiment, the wholesaling retailer would enter the security key found on the back of the card when the consumer arrives at the store. The card reader, or browser based interface, would verify that this security code matches the information submitted by the consumer when they completed their online transaction.

In view the challenges and problems with the prior art described above, it is the objective of the present invention to provide a credit card payment, processing and verification system which reduces the risk of fraud and cost to independent retailers by: 1) enabling traditional retail establishments that are members of an online selling organization to physically verify or swipe a credit card on behalf of fellow independent members that have already transmitted the consumer's (cardholder) credit card information to and received authorization from a processing company, credit card association and the issuing bank online 2) matching the consumer (cardholder) information transmitted and authorized online from the Selling Retailer to the information on the consumer card swiped by the Wholesale Delivery Member that has a physical store within practical proximity of the purchasing consumer 3) Automatically lowering the Internet Discount Rate charged to the Selling Retailer 4) Not charging the Wholesale Delivery Member for processing the card swiped and matched on behalf of the Selling Retailer by the Wholesale Delivery Member 4) Transferring Automated Clearing House (ACH) payments to the Wholesale Delivery Member's bank account to settle the merchandise sold, lent or otherwise provisioned to the Selling Retailer 5) Undertaking other innovative processes and techniques to linking the respective financial interest of independent remote retailers and a single consumer by way of credit card processing, that will become more readily clear upon review of the following description and drawings.

### BRIEF DESCRIPTION OF THE DRAWINGS

FIG. 1 illustrates an exemplary computer system that may be used to execute the software of an embodiment of the invention

FIG. 2 is a block diagram of the exemplary computer system shown in FIG. 1;

FIG. 3 is a flow chart of the prior art method and apparatus for processing a physical (swiped) credit card transaction for a single retailer;

FIG. 4 illustrates an exemplary POS transaction entry terminal that may be used to execute the software of an embodiment of the invention;

FIG. 5 is a block diagram of the exemplary POS transaction entry terminal system shown in FIG. 4;

FIG. 6 is a flow chart of a process flow of the prior art method and apparatus for processing an online credit card transaction for a single retailer; and

FIG. 7 is a flow chart illustrating processing a credit card transaction using two retailers, one acting as an online retailer and another acting as a wholesale and delivering merchant, in accordance with the aspects of the present invention;

### DETAILED DESCRIPTION OF PREFERRED EMBODIMENTS

In the description that follows, the following terms take the meanings explicitly associated in this application, unless the context obviously indicates otherwise.

The term “Selling Retailer” refers to a traditional retail establishment that is an independent member of an online selling organization for multiple retailers, such merchant having made an online sale to a consumer that is not within the practical geographic trade area of the merchant's physical store and, such merchant having simultaneously purchased, borrowed or otherwise provisioned the item(s) sold to the consumer from another independent member (see “Wholesale Delivery Member”) that does have a physical store within practical proximity to the consumer.

The term “Wholesale Delivery Member” refers to a traditional retail establishment that is an independent member of an online selling organization for multiple retailers, such merchant having sold, lent or otherwise provisioned items to a Selling Retailer that sold the such items to a consumer outside of the practical geographic trade area of the Selling Retailer, such Wholesale Delivery Member having a physical store within reasonable proximity to the consumer to allow physical delivery of the item(s) by the Wholesale Delivery Member to the consumer.

The terms “customer” and “consumer” are used interchangeably throughout.

The terms “merchant” and “retailer” are used interchangeably throughout.

Thee terms “Internet Payment Gateway” or simply “Gateway” refer to an Internet based service that encrypts and decrypt payment information and communicates with banking networks to enable online or “e-commerce” transactions.

The term “processor” is generally used herein to refer to a credit card processing company unless otherwise indicated by the context. As such, the term may also refer to a component of a computer, such as a central processing unit (or “CPU”), which is also sometimes simply referred to in the art as a “processor.”

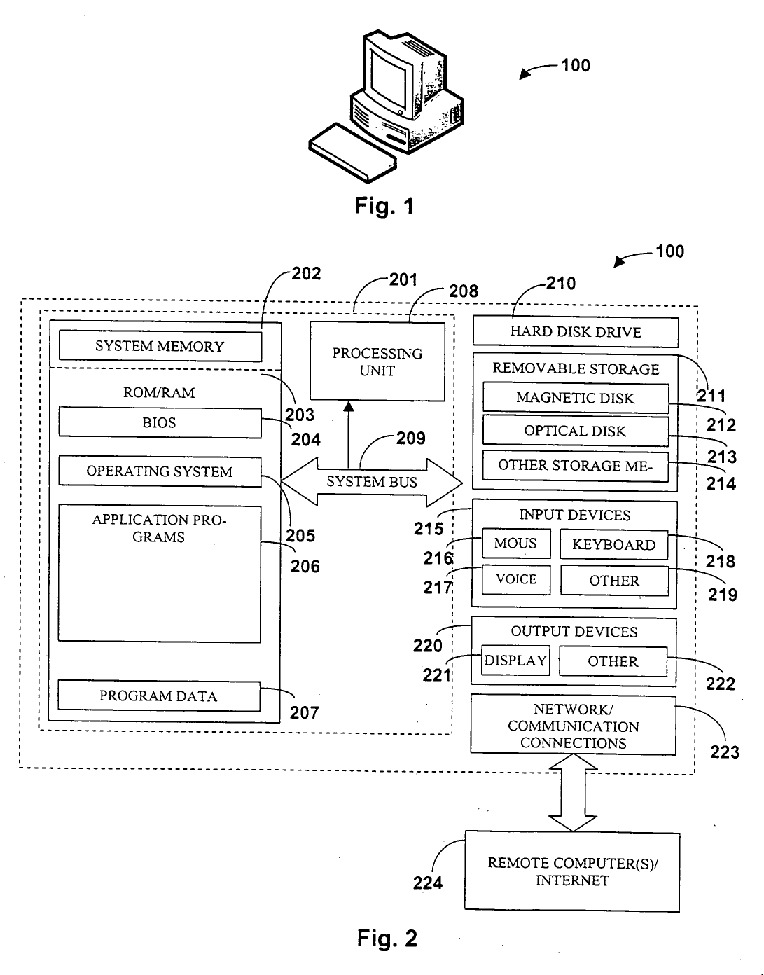

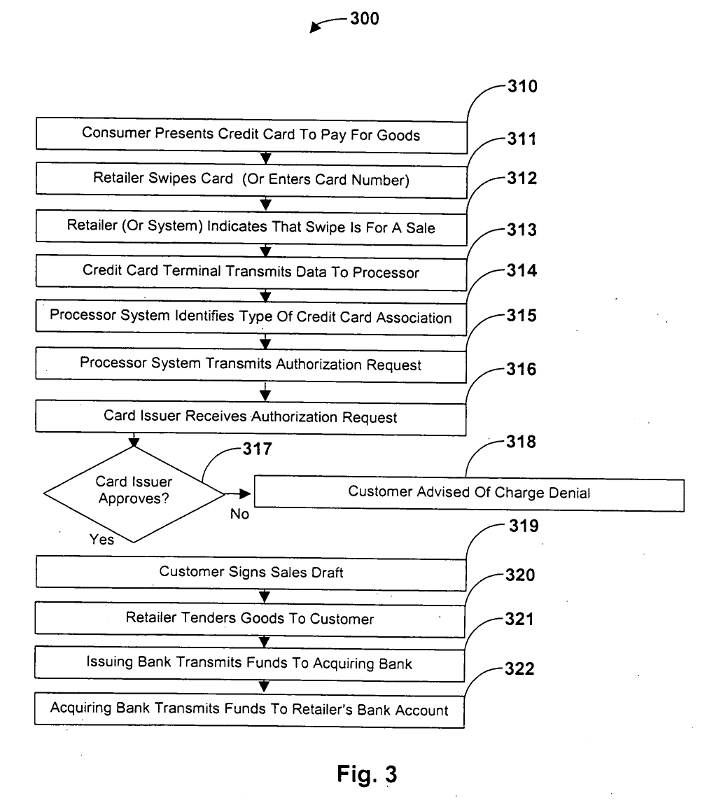

FIG. 1 illustrates an exemplary computer system 100 that may be used to execute the software of an embodiment of the invention and FIG. 2 shows a block diagram of the exemplary computer system 100 shown in FIG. 2, including; output devices 221, such as, but not limited to, a display 222, and other output devices 223; input devices 216 such as, but not limited to, a mouse 217, a voice input device 218, a keyboard 219 and other input devices 220; removable storage 211 that may be used to store and retrieve software programs incorporating code that aids or executes the invention or stores data for use with the invention, or otherwise interacts with the invention, such as, but not limited to, magnetic disk storage 212, optical storage 213 and other storage 214 that; a hard drive 210 that may be used to store and retrieve software programs incorporating code that aids or executes the invention or stores data for use with the invention, or otherwise interacts with the invention; and typical system components, such as those within dashed line 201, including but not limited to system memory 202, which typically contains BIOS (Basic Input Output System) 204, RAM (Random Access Memory) and ROM (Read Only Memory) 203, an operating system 205, application programs 206, program data 207, a processing unit 208, system bus 209, and network and or communications connections 224 to remote computers and or the Internet 225.

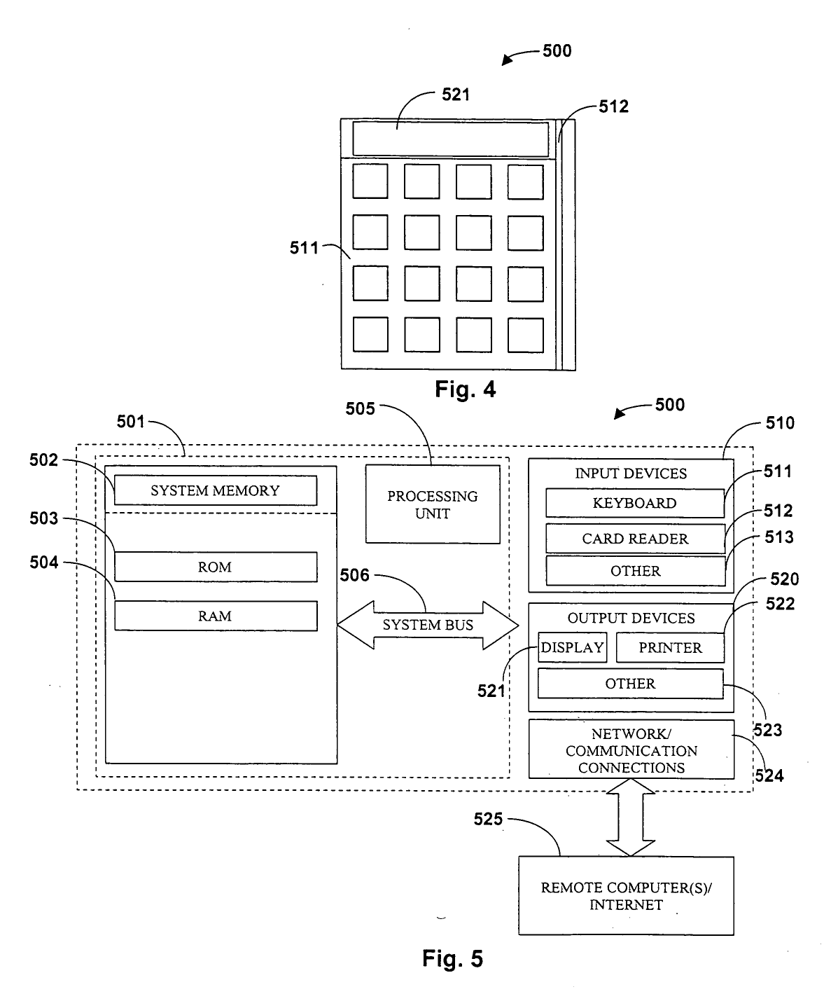

FIG. 4 illustrates an exemplary POS transaction entry terminal that may be used to execute the software of an embodiment of the invention, such as POS transaction entry terminal 500. In a very basic configuration, POS transaction entry terminal 500 typically includes a display 521, a credit (or debit) card reader 512 and a keyboard 511. Additional items typically found in POS transaction terminal 500 included those noted in FIG. 5.

FIG. 5 is a block diagram of the exemplary POS transaction entry terminal system shown in FIG. 4, including; output devices 520, such as, but not limited to, a display 521, a printer 522, and other output devices 523; input devices 510 such as, but not limited to, a keyboard 511, a card reader 512 and other input devices 513;; and typical system components, such as those within dashed line 501, including a variety of storage and memory devices that may be used to store and retrieve software programs incorporating code that aids or executes the invention or stores data for use with the invention, or otherwise interacts with the invention, such as, but not limited to, 503 RAM (Random Access Memory) and 504 ROM (Read Only Memory), 502 system memory; a processing unit 505 and possibly a system bus 506; and network and or communications connections 524 to remote computers and or the Internet 525.

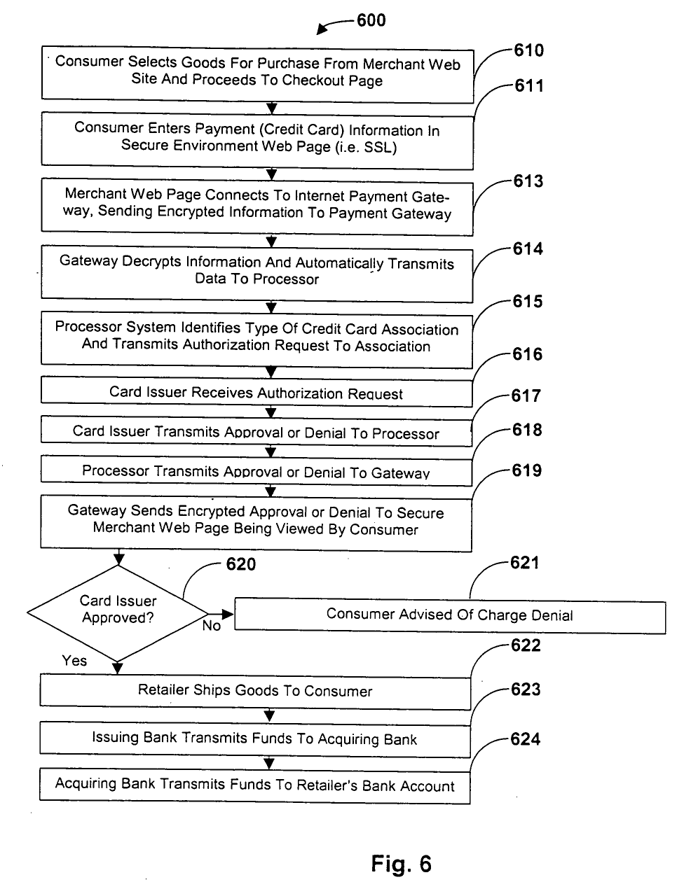

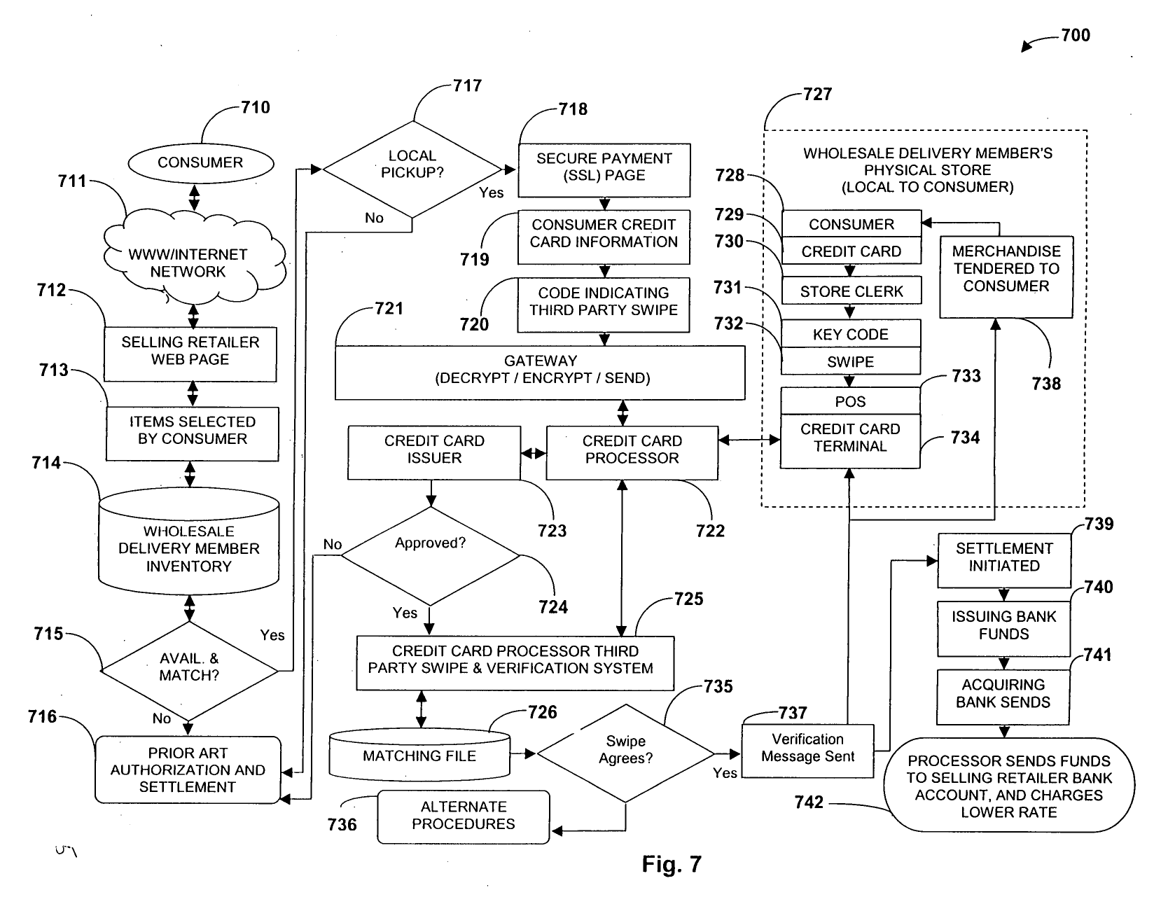

FIG. 7 is a flow chart illustrating processing a credit card transaction using two retailers, one acting as an online retailer and another acting as a wholesale and delivering merchant, in accordance with the aspects of the present invention. The preferred embodiment of the present invention 700 begins as a consumer 710, utilizing a computing device connecting to the Internet 711, such as the computing device shown in FIG. 1 and FIG. 2, selects items for purchase 713 from the Selling Retailer's web page 712. The present invention compares the items selected by the consumer 713 to a database 714 that contains items currently available at a member retailer (Wholesale Delivery Member) closest to the consumer. If the items are not available and or do not match 715 the items selected by the consumer 713, the consumer and the system proceed with the prior art method of online processing, authorization and settlement 716, see FIG. 6 and 600. If these items are available and match 715 the items selected by the consumer 713, the consumer is presented with the option of local pickup 717 for the items that were matched and available.

As illustrated in FIG. 7, if the consumer 710 chooses not to pick up the items locally 717, the consumer and the system proceed with the prior art method of online processing, authorization and settlement 716, see FIG. 6 and 600. If the consumer 710 chooses to pick up the items locally 717, the consumer and the system proceed with the present invention's method and system for processing, authorization and settlement, displaying a Secure Payment (SSL) page 718 that has been programmed to facilitate storing, sending and retrieving software programs incorporating code that aids or executes the present invention or stores data for use with the invention, or otherwise interacts with the invention. The consumer 710 enters their credit (or debit) card information 719 into the Secure Payment (SSL) page 718. After the consumer instructs the secure page to do so, typically by clicking a submit button or series of buttons, the merchant web page connects to the Internet Payment Gateway (or “Gateway”) and sends encrypted information regarding the transaction and payment card to the Gateway 721. This procedure is similar to that of the prior art, shown in FIG. 6 item 613 except that in addition to the Secure Payment (SSL) page 718 in FIG. 7 transmitting, in encrypted form, the consumer credit card information 719 and order details, the Secure Payment (SSL) page 718 also transmits, in encrypted form, a code indicating that a third party swipe 720 will be used to physically verify the credit card upon pickup of the merchandise from the Wholesale Delivery Member's physical store 727.

The Gateway in FIG. 7 decrypts this transaction and payment information 719 and automatically routs the information to the retailer's credit card processor 722. In the present invention, the Gateway in FIG. 7 also sends information that will allow the credit card processor 722 to identify the transaction as one utilizing the processor's third-party swipe and verification system 725 configured in accordance with the present invention, and also enabling the processor to identify and retrieve the merchant account details of the Wholesale Delivery Member 727, utilizing the code indicating a third party swipe 720.

The credit card processor 722, in FIG. 7, automatically routs the consumer credit card information 719 to the appropriate card association and or issuer 723 for approval. If the transaction is not approved 724 by the credit card issuer 723, the consumer 710 and the system 700 proceed with the steps of online processing, authorization and settlement 716, see FIG. 6 and 600. However, if the transaction is approved by the credit card issuer 723, the credit card processor 722, in FIG. 7, has been instructed by the code in 720 to route certain data regarding the transaction, card information and Wholesale Delivery Member 727 to the processor's third-party swipe and verification system 725 configured in accordance with the present invention, and a matching database 726, also configured in accordance with the present invention, that will be used to identify and retrieve the merchant account details of the Wholesale Delivery Member 727 and verify that the credit card 730 matches when presented by the consumer 728 in person.

Upon receiving an approval 724, in FIG. 7, the consumer is notified, then the Wholesale Delivery Member 727 is also made aware of the transaction, allowing them to pick the items ordered from Selling Retailer Web page 712 from the shelves of Wholesale Delivery Member 727 in advance of consumer 728 arriving to complete the transaction. Most importantly, unlike the prior art, where no physical validation or verification of the credit card will likely take place before capturing the transaction and settling amount due to the acquiring bank and merchant, the present invention as depicted in FIG. 7 requires that the consumer 728 bring the credit card 730 they used to provide the credit card information 719 that was previously used to approve 724 the transaction for the items selected 713 from Selling Retailer Web Page 712, before any funds are paid to the Selling Retailer's bank account.

As illustrated in FIG. 7, when the consumer 728 arrives at the Wholesale Delivery Member's Physical Store 727, the store clerk 731 or other store personnel, will enter a key code 731 into their POS 733 and or credit card terminal 734. This key code will allow the their POS 733 and or credit card terminal 734 to recognize the upcoming credit card swipe 732 as a swipe to be matched with a third-party transaction that was previously entered into by the consumer 728 cardholder at the Selling Retailer Web Page 712, and that the swipe 732 is solely to physically verify and validate the card presented as being identical. After swiping the card, the POS 733 and or credit card terminal 734 transmit the card information to the credit card processor 722, which automatically routes the information to their third-party swipe and verification system 725 configured in accordance with the present invention, and a matching database 726, also configured in accordance with the present invention, to identify and retrieve the merchant account details of the Wholesale Delivery Member 727 and verify that the credit card 730 matches when presented by the consumer 728 in person.

The third-party swipe and verification system 725 configured in accordance with the present invention, and a matching database 726, also configured in accordance with the present invention, will first compare the card information from the credit card 730 swiped 732 at the Wholesale Delivery Member's Physical Store 727 to the credit card information saved for matching in the matching file 726. If the information matches 735, the system will then send a verification message 737 from the credit card processor 722 system to the POS 733 and or credit card terminal 734 at the Wholesale Delivery Member's Physical Store 727 where the credit card 730 was swiped 732. In response to the verification message, the Store Clerk 730 will tender the merchandise 738 to the consumer 728. After, or before, tendering the merchandise the Wholesale Delivery Member 730 may require that the consumer 728 sign a sales draft or other document noting receipt of the goods, although this step is not mandatory to have the system process and prevent fraud. Also, after tendering the merchandise the Wholesale Delivery Member 730 may be required to enter a key code to indicate that the transaction was completed with the consumer 728 on behalf of Selling Retailer Web page 712, although this step is not mandatory to have the system process and prevent fraud.

As illustrated in FIG. 7, upon issuing the verification message 727, the processor's third party swipe and verification system 725 configured in accordance with the present invention will initiate settlement 739, insuring that funds are sent from the issuing bank 740 to the acquiring bank 741 and on to the Selling Retailer's bank account, with processing fees reduced to reflect the decreased risk of fraud 742.

If, as illustrated in FIG. 7, the third-party swipe and verification system 725 configured in accordance with the present invention, and a matching database 726, also configured in accordance with the present invention, compares the card information from the credit card 730 swiped 732 at the Wholesale Delivery Member's Physical Store 727 to the credit card information saved for matching in the matching file 726 and the information does not match 735, alternate procedures 736 can be undertaken to confirm the identify of the consumer and the credit card. Such alternate procedures can include calling the issuing bank or processor for phone based interviews and confirmations, as is done in the prior art, but with the sole purpose of verifying that the consumer 710 and credit card information 719 are authentically the same consumer 728 and credit card 730. If they are not, the processor will automatically inform the issuing bank and or association 723, thereby further preventing fraud. It will be understood by those skilled in the art that the embodiments set forth hereinbefore are merely exemplary of the numerous arrangements for which the invention may be practiced, and as such may be replaced by equivalents without departing from the invention which will now be defined by appended claims.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1) A method for completing a card transaction for a consumer, comprising the steps of:
presenting card information relating to said card transaction to a first merchant online in order to pay for said merchandise to be delivered to said consumer;
submitting said card information through a gateway of said first merchant to obtain payment approval;
selecting a second merchant to supply said merchandise to said consumer; initiating a verification process by said second merchant by using a gateway of said second merchant to only verify that the card was used to purchase said merchandise;
settling said purchase for said first and second merchants with said card information in accordance with said payment approval.

2) A method for completing a card transaction for a consumer as in claim 1, wherein said first merchant and said second merchant are independent.

3) A method for completing a card transaction for a consumer as in claim 1, wherein said method includes the step of accessing a card database that contains data relating to said card.

4) A method for completing a card transaction for a consumer as in claim 1, where and said step of settling includes the step of charging said first merchant a lower rate for using said card information to pay for said merchandise due to a reduced transaction risk.

5) A method for completing a card transaction for a consumer as in claim 1, wherein said method includes the step of providing said merchandise to said consumer in person.

6) A method for completing a card transaction for a consumer as in claim 1, wherein such verification process does not charge said second merchant for said verification of said card information.

7) A method for completing a card transaction for a consumer as in claim 1, wherein said card information includes credit card information.

8) A method for completing a card transaction for a consumer as in claim 1, wherein said card information includes debit card information.

9) A method for completing a card transaction for a consumer as in claim 1, wherein said settling step includes the step of transferring funds from an account of said consumer to an account of said second merchant.

10) A method for completing a card transaction for a consumer as in claim 1, wherein said submitting step includes the step of submitting third party swipe information.

11) A method for completing a card transaction for a consumer as in claim 10, wherein said third-party swipe information is upcoming third-party swipe information.

12) A method for completing a card transaction for a consumer as in claim 10, wherein said third-party swipe information is previous third-party swipe information.

13) A method for completing a card transaction for a consumer as in claim 1, wherein the method includes the step of notifying said second merchant of said purchase after said payment approval had been obtained.

14) A method for completing a card transaction for a consumer as in claim 13, wherein said second merchant is notified before said consumer arrives at said second merchant.

15) A method for completing a card transaction for a consumer as in claim 1 wherein said verification process includes the step of only transmitting a security key from said card information.

16) A method for completing a card transaction for a consumer as in claim 1 wherein said verification process does not involve a payment for the verification for the second merchant.

17) An apparatus for completing a card transaction for a consumer, comprising:
an apparatus for presenting card information relating to said card transaction to a first merchant online in order to pay for said merchandise to be delivered to said consumer;
a submitting apparatus for submitting said card information through a gateway of said first merchant to obtain payment approval;
a selecting apparatus for selecting a second merchant to supply said merchandise to said consumer;
a verification apparatus for initiating a verification process by said second merchant by using a gateway of said second merchant to only verify that the card was used to purchase said merchandise;
a settling apparatus for settling said purchase for said first and second merchants with said card information in accordance with said payment approval.

18) An apparatus for completing a card transaction for a consumer as in claim 17, wherein said first merchant and said second merchant are independent.

19) An apparatus for completing a card transaction for a consumer as in claim 17, wherein said apparatus includes an accessing apparatus for accessing a card database that contains data relating to said card.

20) An apparatus for completing a card transaction for a consumer as in claim 17, wherein said settling apparatus includes a charging apparatus for charging said first merchant a lower rate for using said card information to pay for said merchandise due to a reduced transaction risk.
